(19) United States
(12) Patent Application Publication
(10) Pub. No.: US 2025/0153511 A1
(43) Pub. Date: May 15, 2025

(54) Tire with Reduced Crown Heating for a Heavy-Duty Construction Plant Vehicle

(71) Applicant: COMPAGNIE GENERALE DES ETABLISSEMENTS MICHELIN, Clermont-Ferrand (FR)

(72) Inventors: Olivier SPINNLER, Clermont-Ferrand Cedex 9 (FR); Thierry ROYER, Clermont-Ferrand Cedex 9 (FR); Natalia BELLIDO-VERA, Clermont-Ferrand Cedex 9 (FR); Olivia CUSCITO, Clermont-Ferrand Cedex 9 (FR)

(21) Appl. No.: 18/720,087

(22) PCT Filed: Dec. 9, 2022
(86) PCT No.: PCT/EP2022/085118

§ 371 Date: Jun. 14, 2024

(30) Foreign Application Priority Data
Dec. 14, 2021 (FR) FR2113428

(51) Int. Cl. B60C 11/01; B60C 1/00

(52) U.S. Cl. CPC B60C 11/01; B60C 2001/0066; B60C 2011/013; B60C 2200/065

(57) ABSTRACT

A tire (1) for a heavy-duty construction plant vehicle, comprising a tread (2) having a height H radially on the outside of at least one low-hysteresis elastomeric mixture layer (41) having an overall filler content TG=TSi+TN, TSi being the silica content and TN the carbon black content. According to the invention, the tread (2) comprises, in the vicinity of at least one axial end (21), a plurality of crown cavities (6) and/or a plurality of lateral cavities (7), respectively distributed in the circumferential direction (XX′): a crown cavity (6) having a depth PS, such that PS/H is at least equal to AS+KS*RSi, with AS=0.35, KS=0.4 and RSi=TSi/TG, a lateral cavity (7) having a depth PF, such that PF/H is at least equal to AF+KF*RSi, with AF=−0.1, KF=0.3 and RSi=TSi/TG.

The present invention relates to a tire for a heavy-duty construction plant vehicle, which is intended to carry heavy loads and to run over uneven and stony ground such as that of mines. This invention relates more particularly to the crown portion of the tire consisting of a tread and a crown.

By definition, the circumferential or longitudinal direction is the direction of rotation of the tire, the axial or transverse direction is the direction parallel to the axis of rotation of the tire and the radial direction is a direction perpendicular to the axis of rotation of the tire.

The tire tread constitutes the peripheral portion of the tire and is intended to wear down when it comes into contact with the ground via a tread surface. It comprises at least one elastomer-based material, generally obtained by mixing a set of components and usually referred to as an elastomeric mixture. It generally comprises a system of cuts separating raised elements, referred to as the tread pattern, intended to guarantee satisfactory performance in terms of longitudinal grip, under engine torque and under braking torque, as well as transverse grip.

The crown is the portion of the tire providing radially internal support for the tread and has the function of transmitting the rolling forces exerted on the tire between the tread and the radial carcass reinforcement of the tire. It is made up of a radial stack of elastomeric mixture layers and reinforcing layers comprising reinforcers, most often metal, coated in mixtures.

The crown portion of the tire consisting of the tread and the crown is extended radially inwards, at each of its axial ends, by a sidewall connected to a bead, for joining the tire to a mounting rim.

A problem that repeatedly arises in tires for heavy-duty construction plant vehicles is a significant rise in the internal temperature of the crown, owing to the particularly severe driving conditions: high loads, sustained speeds, sloping and twisty routes, uneven and stony ground. This high temperature is due both to the great thickness of the tread on top of the crown, typically at least equal to 60 mm, and to the high heat dissipation of the elastomeric mixtures present inside the crown, usually referred to as internal elastomeric mixtures. An excessive rise in internal temperature can cause premature deterioration of the components of the crown and lead to the tire being scrapped.

It is known that elastomeric mixtures which comprise silica among their reinforcing fillers have lower hysteresis, that is to say heat dissipation, compared to elastomeric mixtures comprising mainly carbon black among their reinforcing fillers, as described, for example, in document FR 9901766; this makes it possible to reduce the heat generated in the elastomeric mixture concerned, in use.

It is also known that, correlatively, elastomeric mixtures comprising mainly silica, for example a content at least equal to 30 phr (parts per hundred of rubber (elastomer), by weight), have a lower thermal conductivity than elastomeric mixtures comprising carbon black, for example a content at least equal to 30 phr; in manufacturing, during the tire curing stage, this significantly increases the curing time necessary to reach the desired level of vulcanization of the elastomeric mixture. This increase in curing time is particularly significant for a construction plant tire, which typically has large dimensions and, in particular, high tread and crown thicknesses. Consequently, the use in a construction plant tire of internal elastomeric mixtures having, at least partially, silica as filler is a priori detrimental from the point of view of the curing time of the tire, and therefore the productivity of manufacturing.

The inventors set themselves the objective of reducing the temperature of the crown of a tire, more specifically a tire intended for a heavy-duty construction plant vehicle, the crown of which comprises at least one internal elastomeric mixture comprising silica among its reinforcing fillers, without compromising productivity during manufacturing of the tire, at the curing stage.

This objective has been achieved by a tire for a heavy-duty construction plant vehicle, comprising a tread intended to come into contact with the ground via a tread surface, and a crown that is radially on the inside of the tread and radially on the outside of a carcass reinforcement:
the tread having a height H, measured perpendicular to the tread surface, and having an axial width W, measured in an axial direction, parallel to the axis of rotation of the tire, on the tread surface and between two axial ends each extended radially inwards by a lateral edge,
the crown consisting, in a radial direction perpendicular to the axis of rotation of the tire, of a radial stack of at least one elastomeric mixture layer and at least one reinforcing layer,
at least one elastomeric mixture layer, referred to as low-hysteresis, comprising at least one elastomer and reinforcing fillers consisting of silica in a content TSi, and carbon black in a content TN, the overall filler content TG being equal to TSi+TN,
the overall filler content TG being at least equal to 30 phr (parts per hundred parts of rubber (elastomer), by weight) and the silica content TSi being at least equal to 50% of the overall filler content TG,
the tread comprising, in the vicinity of at least one axial end, a plurality of crown cavities, distributed in a circumferential direction, or a plurality of lateral cavities, distributed in the circumferential direction:
a crown cavity of the plurality of crown cavities, extending towards the inside of the tread, from the tread surface to a crown cavity bottom, over a depth PS, such that PS/H is at least equal to AS+KS*RSi, with AS=0.35, KS=0.4 and RSi=TSi/TG,
a lateral cavity of the plurality of lateral cavities, extending towards the inside of the tread, from a lateral edge to a lateral cavity bottom, over a depth PF, such that PF/H is at least equal to AF+KF*RSi, with AF=−0.1, KF=0.3 and RSi=TSi/TG.

The invention essentially consists in positioning, generally in the raised elements of the tread pattern referred to as blocks, located at the axial ends of the tread, at least one plurality of cavities extending in the circumferential direction of the tire, said cavities extending radially inwards, either from the tread surface or from a lateral edge of the tread. Consequently, a tread according to the invention comprises one or the other of the pluralities of cavities described above, or simultaneously both types of pluralities of cavities.

A cavity extending towards the inside of the tread, from the tread surface, is called, by convention, a “crown cavity”, and is, in particular, characterized by its depth PS. The crown cavities of said plurality of crown cavities are not necessarily identical and are not necessarily distributed circumferentially at regular intervals. A crown cavity generally extends inside a raised element of the tread, not in a cut separating two consecutive raised elements.

A cavity extending towards the inside of the tread, from a lateral edge of the tread, is called, by convention, a “lateral cavity”, and is, in particular, characterized by its depth PF. The lateral cavities of said plurality of lateral cavities are not necessarily identical and are not necessarily distributed circumferentially at regular intervals.

According to the invention, the respective depths PS or PF of one or the other of these types of cavities, crown and lateral cavities respectively, expressed in values relative to the height H of the tread, vary linearly as a function of the ratio RSi, obtained by dividing the silica content TSi by the overall filler content TG, these filler contents being relative to the low-hysteresis elastomeric mixture of the crown layer closest to the bottom of said cavity. This crown layer, consisting of an elastomeric mixture with low hysteresis, is designated below using the name “low-hysteresis layer”.

When driving, the presence of such a cavity creates a heat exchange zone near the low-hysteresis layer closest to the bottom of said cavity. This low-hysteresis layer comprises silica among its reinforcing fillers and, compared to an elastomeric mixture filled mainly with carbon black, has lower heat dissipation, but also lower thermal conductivity. Thus, in said low-hysteresis layer, even though the production of heat energy is lower, it is more difficult to discharge the heat energy.

Consequently, the proximity of the cavity facilitates the discharge of the heat energy generated in said low-hysteresis layer, and therefore promotes the lowering of the temperature in this axial end zone of the crown, which is generally hottest.

The more the silica content in the low-hysteresis layer increases, the more the thermal conductivity of said low-hysteresis layer decreases; this requires that the cavity be positioned as close as possible to said low-hysteresis layer, and therefore that the depth of the cavity be increased. The depth of the cavity according to the invention is therefore an increasing function of the silica content. Equivalently, reasoning in relative values, the ratio of the depth of the cavity to the height of the tread is an increasing function of the ratio of the silica content to the overall filler content.

Another significant advantage of the invention is that it makes it possible to reduce the curing time of the tire. More specifically, the mould element for moulding the cavity described above, owing to its proximity to the low-hysteresis layer, supplies heat energy to said low-hysteresis layer. This supply of heat energy is particularly effective owing to the high thermal conductivity of said mould element, which is generally made of metal. Thus, the time required for curing by vulcanization is reduced.

When the tread comprises a plurality of crown cavities, the depth PS of a crown cavity is advantageously at most equal to the height H of the tread. The greater the depth PS of a crown cavity, the smaller the distance from the crown cavity bottom to the low-hysteresis layer. This local reduction in thickness of material, between the crown cavity bottom and the low-hysteresis layer, reduces the protection of the crown and increases its risk of damage following an attack on the tread: hence the need to have an upper limit for the depth PS. Furthermore, if the residual interlayer material between the crown cavity bottom and the low-hysteresis layer has a low content of silica filler, it is then more conductive than the low-hysteresis layer and promotes the discharge of heat energy.

Also advantageously, the crown cavity bottom is positioned at a distance DS from the radially outermost low-hysteresis elastomeric mixture layer which is at most equal to 1.5 times the height H of the tread. This feature is correlated with the minimum depth PS of the crown cavity and has the same technical advantages of improvement in thermal performance during driving and saving in terms of tire curing time, described above.

Even more advantageously, the crown cavity bottom is positioned at a distance DS from the radially outermost low-hysteresis elastomeric mixture layer which is at least equal to 5 mm. This feature is correlated with the maximum depth PS of the crown cavity and has the same technical advantages of limiting the risk of damage to the crown and contributing to the discharge of heat energy, described above.

The crown cavity bottom has a centre that is advantageously positioned, from the nearest axial end, at a distance LS at most equal to 0.25 times the axial width W of the tread. An axial end of the tread generally corresponds to the thickest area of the crown, and therefore to the area in which it is most difficult to discharge heat energy. It is also in this area that the layers for decoupling the various crown reinforcing layers are located, most often consisting of a relatively high thickness of an elastomeric mixture with low hysteresis, and therefore low thermal conductivity. A crown cavity that is too far from an axial end of the tread would therefore be ineffective with regard to the discharge of heat energy.

The crown cavity bottom has a centre that is even more advantageously positioned, from the nearest axial end, at a distance LS at least equal to 0.03 times the axial width W of the tread. A crown cavity that is too close to an axial end of the tread creates fragility, increasing the risk of the edge of the tread being torn off in the event of attack.

Preferably, the plurality of crown cavities is distributed, in the circumferential direction, with a constant pitch. A regular distribution of the crown cavities guarantees heat exchange regularly distributed over the entire circumference of the tire. The constant pitch most often, but not necessarily, corresponds to the distance between the respective centres of two consecutive raised elements of the tread edge.

When the tread comprises a plurality of lateral cavities, the depth PF of a lateral cavity is advantageously at most equal to 50 mm. As for a crown cavity, the greater the depth PF of a lateral cavity, the smaller the distance from the lateral cavity bottom to the low-hysteresis layer. This local reduction in thickness of material, between the lateral cavity bottom and the low-hysteresis layer, reduces the protection of the crown and increases its risk of damage following an attack on the sidewall: hence the need to have an upper limit for the depth PF. Furthermore, if the residual interlayer material between the lateral cavity bottom and the low-hysteresis layer has a low content of silica filler, it is then more conductive than the low-hysteresis layer and promotes the discharge of heat energy.

Also advantageously, the lateral cavity bottom is positioned at a distance DF from the axially outermost low-hysteresis elastomeric mixture layer which is at most equal to 1.3 times the height H of the tread. This feature is correlated with the minimum depth PF of the lateral cavity and has the same technical advantages of improvement in thermal performance during driving and saving in terms of tire curing time, described above.

Even more advantageously, the lateral cavity bottom is positioned at a distance DF from the axially outermost low-hysteresis elastomeric mixture layer which is at least equal to 5 mm. This feature is correlated with the maximum depth PF of the cavity and has the same technical advantages of limiting the risk of damage to the crown and contributing to the discharge of heat energy, described above.

The lateral cavity bottom has a centre that is advantageously positioned, from the nearest axial end, at a distance LF at most equal to 3 times the height H of the tread. An axial end of the tread generally corresponds to the thickest area of the crown, and therefore to the area in which it is most difficult to discharge heat energy. It is also in this area that the layers for decoupling the various crown reinforcing layers are located, most often consisting of a relatively high thickness of an elastomeric mixture with low hysteresis, and therefore low thermal conductivity. A lateral cavity that is too far from an axial end of the tread would therefore be ineffective with regard to the discharge of heat energy.

The lateral cavity bottom has a centre that is even more advantageously positioned, from the nearest axial end, at a distance LF at least equal to the height H of the tread. A lateral cavity that is too close to an axial end of the tread creates fragility, increasing the risk of the edge of the tread being torn off in the event of attack.

Preferably, the plurality of lateral cavities is distributed, in the circumferential direction, with a constant pitch. A regular distribution of the lateral cavities guarantees heat exchange regularly distributed over the entire circumference of the tire. The constant pitch most often, but not necessarily, corresponds to the distance between the respective centres of two consecutive raised elements of the tread edge.

Advantageously, the overall filler content TG of the at least one low-hysteresis elastomeric mixture layer is at most equal to 50 phr (parts per hundred parts of rubber (elastomer), by weight). A higher overall filler content TG, with a higher silica content TSi, would lead to higher hysteresis, increasing the amount of heat energy generated during driving, and to a reduction in the cohesion of the mixture, increasing the risk of it cracking.

Preferably, the silica content TSi of the at least one low-hysteresis elastomeric mixture layer is at least equal to 70% of the overall filler content TG. For a given overall filler content TG, a silica content TSi of 70% guarantees, compared to an elastomeric mixture with carbon black mainly as filler, a lower level of hysteresis with an equivalent modulus of elasticity.

According to a preferred embodiment, the tread comprises, in the vicinity of at least one axial end, a plurality of crown cavities, distributed in a circumferential direction, and a plurality of lateral cavities, distributed in the circumferential direction. The simultaneous presence of two pluralities of cavities, crown and lateral, makes it possible to maximize heat exchange between the crown of the tire and the external environment.

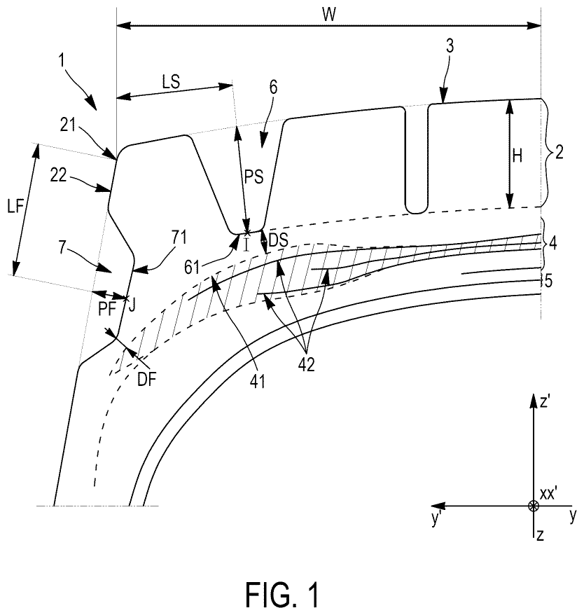

The features of the invention are illustrated by FIGS. 1 to 6 below, which are schematic and not drawn to scale:

FIG. 1: View in meridian section of a crown portion of a tire according to a preferred embodiment of the invention,

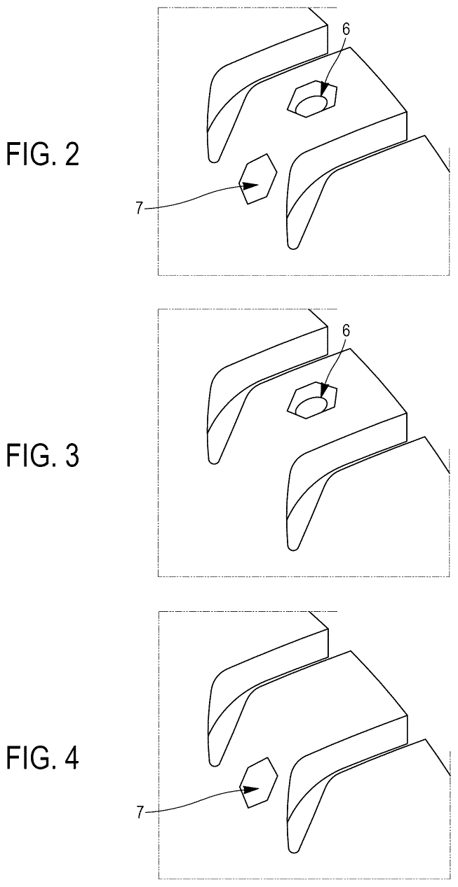

FIG. 2: Perspective view of a crown portion of a tire according to a preferred embodiment of the invention,

FIG. 3: Perspective view of a crown portion of a tire according to a first embodiment of the invention,

FIG. 4: Perspective view of a crown portion of a tire according to a second embodiment of the invention,

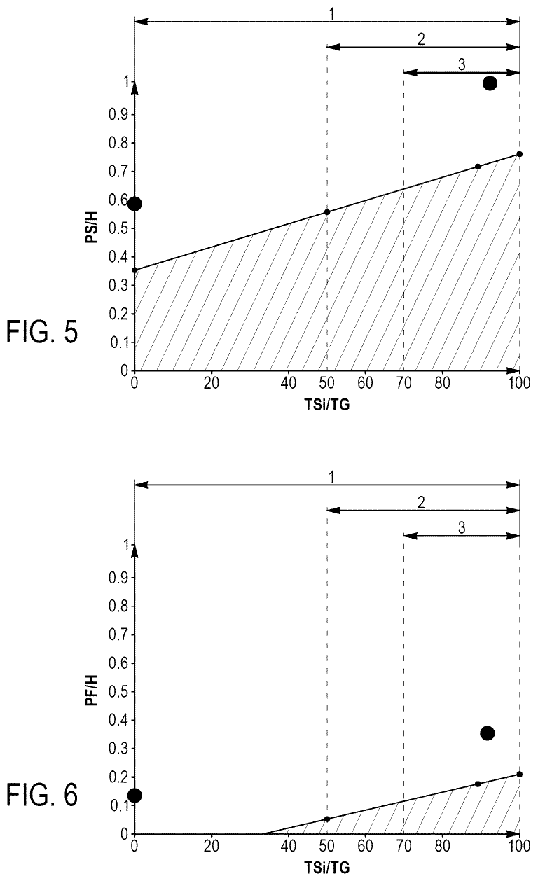

FIG. 5: Range of variation of the ratio “crown cavity depth PS/tread pattern depth H” as a function of the ratio “silica content TSi/overall filler content TG”,

FIG. 6: Range of variation of the ratio “lateral cavity depth PF/tread pattern depth H” as a function of the ratio “silica content TSi/overall filler content TG”.

FIG. 1 is a view in meridian section of a crown portion of a tire according to a preferred embodiment of the invention, combining two pluralities of cavities, namely crown 6 and lateral 7. The tire 1 comprises a tread 2, intended to come into contact with the ground via a tread surface 3, and a crown 4, radially on the inside of the tread 2 and radially on the outside of a carcass reinforcement 5. The tread 2 has a height H, measured perpendicular to the tread surface 3, and has an axial width W, measured in an axial direction YY′, parallel to the axis of rotation of the tire, on the tread surface 3 and between two axial ends 21 each extended radially inwards by a lateral edge 22. The crown 4 consists, in a radial direction ZZ′ perpendicular to the axis of rotation of the tire, of a radial stack of at least one elastomeric mixture layer 41 and at least one reinforcing layer 42.

An elastomeric mixture layer 41, referred to as low-hysteresis, depicted by hatching in FIG. 1, comprises at least one elastomer and reinforcing fillers consisting of silica in a content TSi, and carbon black in a content TN, the overall filler content TG being equal to TSi+TN. The overall filler content TG is at least equal to 30 phr (parts per hundred parts of rubber (elastomer), by weight) and the silica content TSi is at least equal to 50% of the overall filler content TG. According to the preferred embodiment of the invention shown, the tread comprises, in the vicinity of the axial end 21, a plurality of crown cavities 6, distributed in a circumferential direction XX′, and a plurality of lateral cavities 7, distributed in the circumferential direction XX′. In the meridian plane YZ in FIG. 1, the crown cavity 6 of the plurality of crown cavities extends towards the inside of the tread 2, from the tread surface 3 to a crown cavity bottom 61, over a depth PS, such that PS/H is at least equal to AS+KS*RSi, with AS=0.35, KS=0.4 and RSi=TSi/TG. The lateral cavity 7 of the plurality of lateral cavities extends towards the inside of the tread 2, from a lateral edge 22 to a lateral cavity bottom 71, over a depth PF, such that PF/H is at least equal to AF+KF*RSi, with AF=−0.1, KF=0.3 and RSi=TSi/TG. The crown cavity bottom 61 is positioned at a distance DS from the radially outermost low-hysteresis elastomeric mixture layer 41 and has a centre I positioned, from the nearest axial end 21, at a distance LS. The lateral cavity bottom 71 is positioned at a distance DF from the axially outermost low-hysteresis elastomeric mixture layer 41 and has a centre J positioned, from the nearest axial end 21, at a distance LF.

FIG. 2 is a perspective view of a crown portion of a tire according to the preferred embodiment of the invention described in FIG. 1 with, in the vicinity of each axial end of the tread, a plurality of crown cavities 6 and a plurality of lateral cavities 7, both distributed, in the circumferential direction of the tire, with a pitch equal to the distance between the respective centres of two consecutive raised elements of the tread edge.

FIG. 3 is a perspective view of a crown portion of a tire according to a first embodiment of the invention with, in the vicinity of each axial end of the tread, a plurality of crown cavities 6 distributed, in the circumferential direction of the tire, with a pitch equal to the distance between the respective centres of two consecutive raised elements of the tread edge.

FIG. 4 is a perspective view of a crown portion of a tire according to a second embodiment of the invention with, in the vicinity of each axial end of the tread, a plurality of lateral cavities 7 distributed, in the circumferential direction of the tire, with a pitch equal to the distance between the respective centres of two consecutive raised elements of the tread edge.

FIG. 5 shows the range of variation of the ratio “crown cavity depth PS/tread pattern depth H” as a function of the ratio “silica content TSi/overall filler content TG”. Range 1, positioned above the hatched part, delimited by the line PS/H=AS+KS*RSi, with AS=0.35, KS=0.4 and RSi=TSi/TG, is the range studied by the inventors, corresponding to a ratio RSi=TSi/TG of between 0% and 100%. Range 2 is the range of the invention corresponding to a ratio RSi=TSi/TG at least equal to 50%. Range 3 is a preferential limitation of range 2 corresponding to a ratio RSi=TSi/TG at least equal to 70%.

FIG. 6 shows the range of variation of the ratio “lateral cavity depth PF/tread pattern depth H” as a function of the ratio “silica content TSi/overall filler content TG”. Range 1, positioned above the hatched part, delimited by the line PF/H=AF+KF*RSi, with AF=−0.1, KF=0.3 and RSi=TSi/TG, is the range studied by the inventors, corresponding to a ratio RSi=TSi/TG of between 0% and 100%. Range 2 is the range of the invention corresponding to a ratio RSi=TSi/TG at least equal to 50%. Range 3 is a preferential limitation of range 2 corresponding to a ratio RSi=TSi/TG at least equal to 70%.

A tread of a tire according to a preferred embodiment of the invention, as described in FIGS. 1, 2, 5 and 6, was studied by the inventors in the tire size 50/80 R 57, intended for a heavy-duty construction plant vehicle, more specifically a dumper. Such a tire is designed to bear a load equal to 67000 kg, for an inflation pressure equal to 6.5 bar.

Table 1 below presents the characteristics of the tread according to the invention I tested, compared with those of a tread of a reference tire R:

TABLE 1

| Characteristics | Reference R | | Invention I | |
|---|---|---|---|---|
| Tread width W (mm) | 1030 | mm | 1030 | mm |
| Tread height H (=Depth of the | 94 | mm | 84 | mm |
| deepest cut) (mm) | | | | |
| Crown cavity depth PS (mm) | 55 | mm | 84 | mm |
| Distance DS (between crown cavity | — | | 18 | mm |
| bottom and the radially outermost | | | | |
| low-hysteresis elastomeric mixture | | | | |
| layer) (mm) | | | | |
| Distance LS (between centre of crown | 125 | mm | 95 | mm |
| cavity bottom and axial end of tread) | | | | |
| (mm) | | | | |
| Lateral cavity depth PF (mm) | 12 | mm | 29 | mm |
| Distance DF (between lateral cavity | — | | 9 | mm |
| bottom and the radially outermost | | | | |
| low-hysteresis elastomeric mixture | | | | |
| layer) (mm) | | | | |
| Distance LF (between centre of lateral | 154 | mm | 150 | mm |
| cavity bottom and axial end of tread) | | | | |
| (mm) | | | | |
| Silica content TSi (phr) | 0 | phr | 40 | phr |
| Carbon black content TN (phr) | 41 | phr | 3 | phr |
| Overall filler content TG = TSi + TN | 41 | phr | 43 | phr |
| (phr) | | | | |
| Ratio RSi = Silica content TSi/Overall | 0% | | 93% | |
| filler content TG (%) | | | | |
| Relative difference in curing time at | Ref | | −8.3% | |
| reference R (%) | | | | |

The saving in terms of tire curing time during manufacturing is estimated at 8.3%, compared to the reference tire, using a digital simulation to determine the level of vulcanization of the various components of the tire.

The improvement in thermal performance observed in the test is 8° C. at the hottest point in the crown of the tire, compared to the reference tire. This measurement is carried out in steady state, at the nominal speed of the vehicle, at the nominal pressure of the tire, and at 0.8 times the nominal load capacity of the tire, these nominal characteristics being the values as defined in particular, for example, by the standard ISO 4250 and the standard of the Tire and Rim Association (TRA).

1. A tire for a heavy-duty construction plant vehicle, comprising a tread, intended to come into contact with the ground via a tread surface, and a crown, radially on the inside of the tread and radially on the outside of a carcass reinforcement:
the tread having a height H, measured perpendicular to the tread surface, and having an axial width W, measured in an axial direction (YY′), parallel to the axis of rotation of the tire, on the tread surface and between two axial ends each extended radially inwards by a lateral edge,
the crown consisting, in a radial direction (ZZ′) perpendicular to the axis of rotation of the tire, of a radial stack of at least one elastomeric mixture layer and at least one reinforcing layer,
at least one elastomeric mixture layer, referred to as low-hysteresis, comprising at least one elastomer and reinforcing fillers comprising silica in a filler content TSi, and carbon black in a filler content TN, the overall filler content TG being equal to TSi+TN,
the overall filler content TG being at least equal to 30 phr (parts per hundred parts of rubber (elastomer), by weight) and the silica content TSi being at least equal to 50% of the overall filler content TG,
wherein the tread comprises, in the vicinity of at least one axial end, a plurality of crown cavities, distributed in a circumferential direction (XX′), and/or a plurality of lateral cavities, distributed in the circumferential direction (XX′):
a crown cavity of the plurality of crown cavities, extending towards the inside of the tread, from the tread surface to a crown cavity bottom, over a depth PS, such that PS/H is at least equal to AS+KS*RSi, with AS=0.35, KS=0.4 and RSi=TSi/TG,
a lateral cavity of the plurality of lateral cavities, extending towards the inside of the tread (from a lateral edge to a lateral cavity bottom, over a depth PF, such that PF/H is at least equal to AF+KF*RSi, with AF=−0.1, KF=0.3 and RSi=TSi/TG.

2. The fire according to claim 1, the tread comprising a plurality of crown cavities, wherein the depth PS of a crown cavity is at most equal to the height H of the tread.

3. The tire according to claim 2, wherein the crown cavity bottom is positioned at a distance DS from the radially outermost low-hysteresis elastomeric mixture layer which is at most equal to 1.5 times the height H of the tread.

4. The fire according to claim 2, wherein the crown cavity bottom is positioned at a distance DS from the radially outermost low-hysteresis elastomeric mixture layer which is at least equal to 5 mm.

5. The tire according to claim 2, wherein the crown cavity bottom has a centre (I) that is positioned, from the nearest axial end, at a distance LS at most equal to 0.25 times the axial width W of the tread.

6. The tire according to claim 2, wherein the crown cavity bottom has a centre (I) that is positioned, from the nearest axial end, at a distance LS at least equal to 0.03 times the axial width W of the tread.

7. The fire according to claim 2, wherein the plurality of crown cavities is distributed, in the circumferential direction (XX′), with a constant pitch.

8. The fire according to claim 1, the tread comprising a plurality of lateral cavities, wherein the depth PF of a lateral cavity is at most equal to 50 mm.

9. The fire according to claim 8, wherein the lateral cavity bottom is positioned at a distance DF from the axially outermost low-hysteresis elastomeric mixture layer which is at most equal to 1.3 times the height H of the tread.

10. The fire according to claim 8, wherein the lateral cavity bottom is positioned at a distance DF from the axially outermost low-hysteresis elastomeric mixture layer which is at least equal to 5 mm.

11. The fire according to claim 8, wherein the lateral cavity bottom has a centre (J) that is positioned, from the nearest axial end, at a distance LF at most equal to 3 times the height H of the tread.

12. The tire according to claim 8, wherein the lateral cavity bottom has a centre (J) that is positioned, from the nearest axial end, at a distance LF at least equal to the height H of the tread.

13. The tire according to claim 8, wherein the plurality of lateral cavities is distributed, in the circumferential direction (XX′), with a constant pitch.

14. The fire according to claim 1, wherein the overall filler content TG of the at least one low-hysteresis elastomeric mixture layer is at most equal to 50 phr (parts per hundred parts of rubber (elastomer), by weight).

15. The fire according to claim 1, wherein the silica content TSi of the at least one low-hysteresis elastomeric mixture layer is at least equal to 70% of the overall filler content TG.
